(19) United States
(12) Patent Application Publication
(10) Pub. No.: US 2002/0030736 A1
(43) Pub. Date: Mar. 14, 2002

(54) Single camera alignment system using up/down optics

(75) Inventors: Edison T. Hudson, Chapel Hill, NC (US); Ernest H. Fischer, Seedorf (CH)

Correspondence Address: David B. Ritchie, Thelen Reid & Priest LLP, P.O. Box 640640, San Jose, CA, 95164-0640, US

(73) Assignee: Infotech AG

(21) Appl. No.: 09/801,561

(22) Filed: Mar. 7, 2001

Related U.S. Application Data
(60) Provisional application No. 60/188,359, filed on Mar. 10, 2000.

(51) Int. Cl. H04N 9/47

(52) U.S. Cl. 348/86; 348/87; 348/95

(57) ABSTRACT

An electronic imaging system for component to substrate alignment utilizes a single imager and a moveable reflector mounted together in an imager body. The imager body can move into and out of position between a pick-up head of a placement machine, rework machine or similar device, and a target substrate. The imager moves into position for performing alignment tasks. The moveable reflector moves to a first position to image a component held by the pick-up head and a second position to image the substrate. This may be accomplished by mounting the reflector for rotational movement. The imager then moves out of position to permit the pick-up head to perform its placement tasks once alignment is determined. The component can thus be imaged while the pick-up head carries the component from the pick-up position to the place position.

### RELATED APPLICATIONS

This application claims the benefit of provisional U.S. patent application Ser. No. 60/188,359 filed on Mar. 10, 2000 in the names of Edison T. Hudson and Ernest H. Fischer and commonly assigned herewith.

### FIELD OF THE INVENTION

The present invention is related to the alignment and registration of components onto substrates in a machine placement environment. More particularly, the present invention is directed to a method for employing a single electronic imager to facilitate accurate alignment and registration of components to substrate features. The components may be electronic, electro-optic, electromechanical, optical, mechanical, microelectronic machine (MEMS) devices, biological material, and the like.

### BACKGROUND OF THE INVENTION

Robotic assembly equipment is well known in the art. Such equipment includes, for example., pick and place (or placement) machines. A placement machine is a robotic instrument for picking up electronic and similar parts from component feeders and placing them at their assigned locations on a printed circuit board (PCB). Once all parts are placed, the PCB is placed in a reflow oven and solder paste disposed on the PCB melts or “reflows” forming permanent electrical connections between conductive pads on the PCB and electrical contacts, leads or “pins” on the electrical components.

Occasionally there are problems with the permanent electrical connections. For example, two pads of the PCB may become inadvertently bridged by solder, forming a short; the component may be mis-located; the component may prove faulty; and the like. In these situations, it is often economically desirable to salvage the partially assembled PCB rather than to scrap it. In order to salvage the PCB, one must remove the faulty component, re-prepare the PCB surface, and place and solder a new component (or a cleaned component) in the correct position on the PCB. This process is termed “rework”. Reworking thus involves reflowing the solder of an identified target component (and not that of the entire PCB), removing the faulty component; cleaning and refluxing the PCB in the location where the component is to be mounted, reinstalling the component and reflowing the solder for the component.

In the past, most known rework systems operate almost entirely manually, i.e., a skilled operator, using an optical magnification system which views both the PCB top surface and the component bottom surface, manually aligns the PCB and the component for placement. Placement systems, on the other hand, typically employ machine vision systems to automate this process. However, most known systems utilize a pair of imagers. One imager views the top surface of the PCB to obtain PCB alignment information by imaging known reference points on the PCB (known in the art as “fiducials”) and/or by imaging contact pads on the PCB, another imager views the component, its bottom and/or its sides, to determine component alignment information. Since such machine vision imagers are relatively expensive, it would be desirable to employ a single machine vision imager to capture all images necessary to provide automated placement and rework capabilities to placement and rework equipment.

### BRIEF DESCRIPTION OF THE INVENTION

An electronic imaging system for component to substrate alignment utilizes a single imager and a moveable reflector mounted together in an imager body. The imager body can move into and out of position between a pick-up head of a placement machine, rework machine or similar device, and a target substrate. The imager moves into position for performing alignment tasks. The moveable reflector moves to a first position to image a component held by the pick-up head and a second position to image the substrate. This may be accomplished by mounting the reflector for rotational movement. The imager then moves out of position to permit the pick-up head to perform its placement tasks once alignment is determined. The component can thus be imaged while the pick-up head carries the component from the pick-up position to the place position.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a schematic diagram of a placement machine with a single camera alignment system employing “up/down optics” in accordance with a specific embodiment of the present invention.

FIG. 2 is a schematic diagram of a single camera alignment system employing “up/down optics” in accordance with a specific embodiment of the present invention.

FIG. 3A is a schematic diagram of a single camera alignment system employing “up/down optics” showing the moveable image reflector positioned to look up at a component in accordance with a specific embodiment of the present invention.

FIG. 3B is a schematic diagram of a single camera alignment system employing “up/down optics” showing the moveable image reflector positioned to look down at a target substrate in accordance with a specific embodiment of the present invention.

### DETAILED DESCRIPTION

Embodiments of the present invention are described herein in the context of a single camera alignment system using up/down optics. Those of ordinary skill in the art will realize that the following detailed description of the present invention is illustrative only and is not intended to be in any way limiting. Other embodiments of the present invention will readily suggest themselves to such skilled persons having the benefit of this disclosure. For example, although the example described herein relates primarily to electronic component assembly to a substrate PCB, the invention is intended to be equally applicable to the installation of any component to a substrate as well as, for example, to the accurate placement of biological materials on active substrates in the field of molecular and genetic biology. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, certain components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

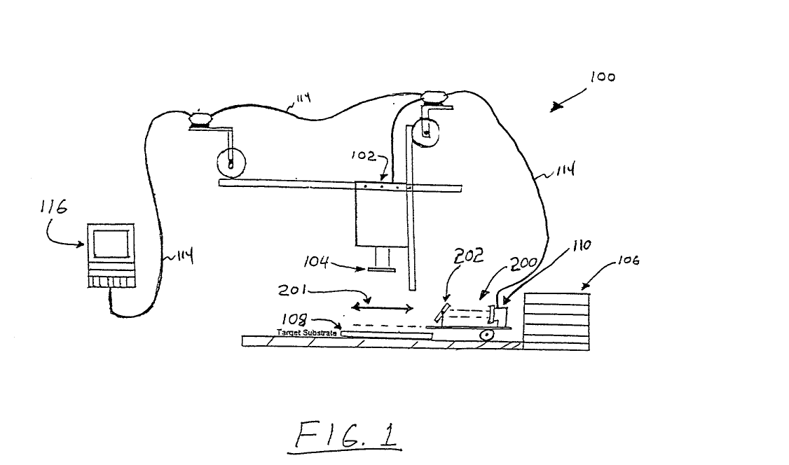

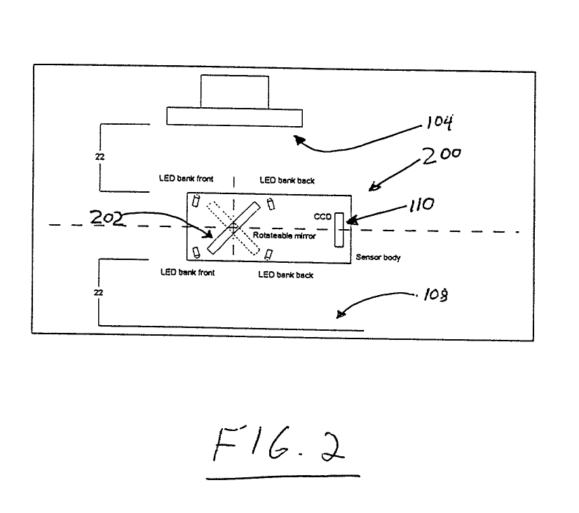

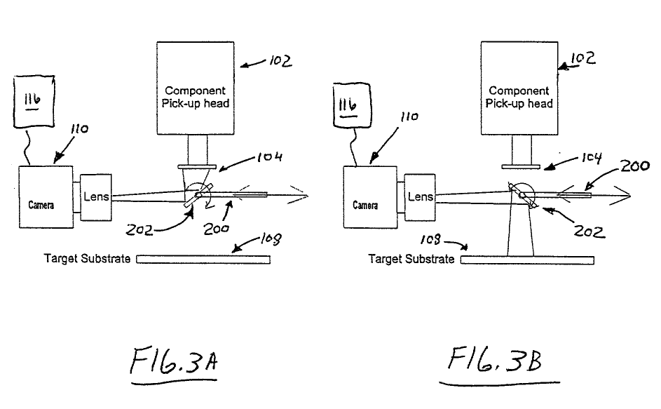

FIGS. 1 and 2 are schematic diagrams of a placement machine (or rework machine) with a single camera alignment system employing “up/down optics” in accordance with a specific embodiment of the present invention. The placement machine 100 of FIG. 1 has a pick-up head 102 transportable in X, Y, Z and T (rotational) directions which picks up components 104 (with a vacuum pick-up, gripper pick-up, or similar device) from component feeders 106 and transports them for placement onto a target substrate 108. The components 104 in accordance with this example are typically electrical, electro-mechanical or electro-optical components and require highly accurate placement onto the target substrate 108 due to typically densely packed input/output (I/O) connections or, in the case of optical components, the need for precise optical alignment. (As discussed above, however, the invention is useable in a broad range of applications extending beyond electronics, mechanics, optics and into biological applications, chemical applications, pharmaceutical applications, and the like). The single camera alignment system as shown in the example of FIG. 1 has an imager body 200 such as that illustrated in FIG. 2 which can move to a position 201 disposed between pick-up head 102 and target substrate 108. The imager body 200 has a rotating reflector element 202 such as a mirror which is moved to a first position (see FIG. 3A) to facilitate scanning the bottom of a component 104 held by the pick-up head 102 and then moved to a second position (see FIG. 3B) to facilitate scanning the target substrate 108. The rotateable reflector element 202 preferably rotates between about 45 and 225 degrees (90 degrees in the example illustrated in FIGS. 3A and 3B). The imager body 200 also has an imaging sensor 110 which captures images of the bottom and/or edge features of a component 104 and the corresponding target substrate 108 features. The imaging sensor 110 can be a conventional linear array imager that is mechanically scanned or an area array-type image sensor that is scanned electronically. The imaging sensor 110 may be any conventional CCD (charge coupled device) imager, a CMOS imager, or a CID device, all of which are well known to those of ordinary skill in the art. Data processing of the images captured by imaging sensor 110 permits calculation of coordinate feature locations for components 104 and target substrates 108 and corresponding control of the pick-up head 102 motion (in X, Y and T directions) to achieve proper registration and alignment between the component 104 and target substrate 108. Such data processing may be performed by a conventional machine vision system as is well understood by those of ordinary skill in the art and may be carried out by computer 116 which is coupled to imaging sensor 110 in a conventional manner with suitable cabling as shown.

Thus, using a single imaging sensor or camera 110, which may be of any suitable type, mounted to the moving carriage 200 of placement machine 100, the image of features of component 104 and the image of the corresponding substrate 108 features or surrogate features (fiducials) can be acquired by interposing a reflector element 202 such as a front surface mirror between the component holder and the substrate, and then by rotating the reflector between about 45 and 225 degrees.

Accuracy is improved by using a single imaging sensor to determine correspondence between component and substrate features and calibration is simplified over the state of the art that uses two different imagers or sensors for this function.

Using the single camera alignment system with up and down optics, the registration of the features of interest of the component may be determined while the component is inflight from the component feeder 106 location and the target substrate 108, thus reducing the total cycle time for assembly by overlapping the registration process.

FIG. 3A is a schematic diagram of a single camera alignment system employing “up/down optics” showing the moveable image reflector positioned to look up at a component in accordance with a specific embodiment of the present invention.

FIG. 3B is a schematic diagram of a single camera alignment system employing “up/down optics” showing the moveable image reflector positioned to look down at a target substrate in accordance with a specific embodiment of the present invention. Those of ordinary skill in the art will now realize that the focal distance between the focal plane of imaging sensor 110 and the surface of the target substrate should be approximately the same as the focal distance between the focal plane of imaging sensor 110 and the surface of interest of the component (e.g., its bottom).

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for obtaining electronic images with a single imager of a substrate location and a component to be placed on the substrate location, said method comprising:
placing the component above the substrate location;
interposing a movable imager body between the substrate location and the component, the imager body including a moveable reflector;
moving the reflector to reflect an image from the component into the imager;
capturing the image of the component;
moving the reflector to reflect an image from the substrate location into the imager;
capturing the image of the substrate location; and
retracting the imager body from between the substrate location and the component.

2. A method for accurately placing a component on a substrate location, said method comprising:
picking the component;
transporting the component to a location above the substrate location;
interposing a movable imager body between the substrate location and the component, the imager body including a moveable reflector;
moving the reflector to reflect an image from the component into the imager;
capturing the image of the component;
moving the reflector to reflect an image from the substrate location into the imager;
capturing the image of the substrate location;
retracting the imager body from between the substrate location and the component; and
placing the component on the substrate location.

3. An apparatus for obtaining electronic images with a single imager of a substrate location and a component to be placed on the substrate location, said apparatus comprising:
means for placing the component above the substrate location;
means for interposing a movable imager body between the substrate location and the component, the imager body including a moveable reflector;
means for moving the reflector to reflect an image from the component into the imager;
means for capturing the image of the component;
means for moving the reflector to reflect an image from the substrate location into the imager;
means for capturing the image of the substrate location; and
means for retracting the imager body from between the substrate location and the component.

4. An apparatus for accurately placing a component on a substrate location, said apparatus comprising:
means for picking the component;
means for transporting the component to a location above the substrate location;
means for interposing a movable imager body between the substrate location and the component, the imager body including a moveable reflector;
means for moving the reflector to reflect an image from the component into the imager;
means for capturing the image of the component;
means for moving the reflector to reflect an image from the substrate location into the imager;
means for capturing the image of the substrate location;
means for retracting the imager body from between the substrate location and the component; and
means for placing the component on the substrate location.

5. A single camera system using up/down optics for component to substrate registration, said system comprising:
a placement machine;
a pick-up head transportable in X, Y, Z and T directions, the pick-up head for picking up a component to be placed at a selected location of the substrate;
an imager body including an imaging sensor mounted to the placement machine so that it can be disposed between a component held by the pick-up head and the selected location of the substrate and then withdrawn; and
a moveable reflector disposed on the imager body, the moveable reflector moveable between a position where an image of the component disposed above the imager body is reflected into the imaging sensor and a position where an image of the selected location of the substrate is reflected into the imaging sensor.

6. A single camera system in accordance with claim 5, wherein said imaging sensor comprises an area array-type imager.

7. A single camera system in accordance with claim 5, wherein said imaging sensor comprises a linear array-type imager.

8. A single camera system in accordance with claim 5, wherein said reflector is rotateable.

9. A single camera system in accordance with claim 8, wherein said reflector rotates in a range of about 45 degrees to about 225 degrees.

10. A single camera system in accordance with claim 9, wherein said reflector comprises a mirror having a reflective front surface.
